(19) United States
(12) Patent Application Publication
(10) Pub. No.: US 2008/0191516 A1
(43) Pub. Date: Aug. 14, 2008

(54) Revolving Working Machine

(75) Inventors: Hiroaki Ayabe, Osaka (JP); Mineaki Ogata, Osaka (JP)

Correspondence Address: STERNE, KESSLER, GOLDSTEIN & FOX P.L.L.C., 1100 NEW YORK AVENUE, N.W., WASHINGTON, DC, 20005, US

(73) Assignee: YANMAR CO., LTD., OSAKA (JP)

(21) Appl. No.: 11/659,281

(22) PCT Filed: Aug. 4, 2004
(86) PCT No.: PCT/JP2004/011178

§ 371 Date: Sep. 20, 2007

(51) Int. Cl. B62D 33/063; E02F 9/16; B60J 7/00; F01P 3/18

(52) U.S. Cl. 296/190.05; 123/41.55; 165/104.19

(57) ABSTRACT

With regard to a revolving working machine that a revolving body is provided on a traveling unit, rearward projection length of the revolving body from revolution center is substantially the same as distance from the revolution center to a side end of a crawler belt, and an engine is cooled by discharging air, an exhaust port through which cooling air is discharged is provided in a bonnet covering the engine, and air guide plates are provided upward in the exhaust port.

### BACKGROUND OF THE INVENTION

1. Field of the Invention

The present invention relates to structure of a revolving body of a revolving working vehicle. Especially, the present invention relates to exhaust structure provided in a bonnet.

2. Background Art

Conventionally, there is well known a revolving working vehicle comprising a revolving body mounted on an upper center of a traveling unit of crawler type or the like at the lower portion of the vehicle body so as to be rotatable laterally.

An engine is provided in the revolving body of such a revolving working vehicle and a radiator or a cooling fan is provided in the vicinity of the engine so as to cool the engine. There is known construction that exhaust after cooling the engine is discharged rearward through an exhaust port opened in the side of the revolving body (for example, see the Patent Literature 1).

An art is disclosed that an exhaust port is provided in a rear portion of a bonnet of a loader and louver mechanism which can change its angle is provided in the exhaust port sp that the angle of the louver is changed upward from a level with the temperature of water of the radiator, pressure oil of a working machine or pressure oil of a traveling unit, thereby reducing noise leaking out from an engine room and improving the cooling efficiency of the engine so as to prevent overheat (see the Patent Literature 2). An art is disclosed that air guide plates are provided in a rear opening of a bonnet so as to discharge exhaust downward (see the Patent Literature 3).

With regard to a working machine of such structure as mentioned above, exhaust is discharged rearward through an exhaust port of a bonnet, whereby the engine exhaust does not blow against thickets close to a wall and an operator or a walker passing at the side of the vehicle.

However, a revolving working vehicle such as a backhoe, especially whose rearward projection length of a revolving body from revolution center is substantially the same as distance from the revolution center to a side end of a crawler belt, that is, a so-called rearward small revolving type working vehicle can revolves and works closely to a wall or a footway, whereby the revolving body is close to the wall and engine exhaust blows a tree directly through an exhaust port so that the tree is blighted. Furthermore, engine exhaust also blows directly an operator or a walker passing at the side of the vehicle, thereby making the operator or the walker unpleasant.

To avoid these problems, it is conceivable to use an engine of suction cooling type. However, with regard to the suction type, heat is accumulated under an operator seat so that an operator room is heated, whereby an operator is made unpleasant.

Patent Literature 1: the Japanese Patent Laid Open Gazette 2001-342644

Patent Literature 2: the Japanese Patent Laid Open Gazette Hei. 11-11162

Patent Literature 3: the Japanese Utility Model Laid Open Gazette Hei. 2-41822

### BRIEF SUMMARY OF THE INVENTION

### Problems to Be Solved by the Invention

The purpose of the present invention is to prevent exhaust from an engine of discharge cooling type from bowing directly a tree and an operator or a walker passing at the side of the machine.

### Means for Solving the Problems

With regard to a revolving working machine according to the present invention, wherein a revolving body is provided on a traveling unit; the revolving body comprises a revolving frame, a counter weight is arranged at a rear portion of the revolving frame, an engine and a radiator are mounted on the revolving frame, and these members are covered by a bonnet; a cooling fan is arranged between the engine and the radiator; an exhaust port is provided in a side surface of the bonnet at a side of the radiator; an air exhaust duct is arranged between the exhaust port and the radiator; the cooling fan is rotatively driven by the engine so as to send cooling air to the radiator; and the cooling air passes through the radiator and is discharged out of the revolving body through the air exhaust duct and the exhaust port of the bonnet, a lower rear portion of the bonnet is notched along shape of a side surface of the counter weight and the exhaust port is shaped along the notch; and an air direction regulation means, regulating direction of exhaust from the exhaust port, is provided near the exhaust port.

With regard to the revolving working machine according to the present invention, as a first mode, a grille stairstep-like shaped in section is formed in the exhaust port, and in the grille, plural air guide plates are constructed by plate-like fins as the air direction regulation means so as to discharge exhaust upward or downward aslant.

The air guide plate upper than a vertical center of the grille is slanted upward and the air guide plate lower than the vertical center is slanted downward.

A stile is interposed between the plural air guide plates.

The grille is detachably attached to the bonnet or the duct.

Otherwise, the grille is formed integrally with the duct of the bonnet, and a part of the plural air guide plates is detachable so that an opening, having enough area to insert a hand thereto, is provided by removing the part of the air guide plates.

With regard to the revolving working machine according to the present invention, as a second mode, air guide plates slanted upward or downward aslant is provided near the exhaust port in the duct as the air direction regulation means.

The air guide plate upper than a vertical center of the duct is slanted upward and the air guide plate lower than the vertical center is slanted downward.

With regard to the revolving working machine according to the present invention, as a third mode, a cover body is provided on the bonnet at an outside of the exhaust port, and an outlet opening is provided between an upper or lower end of the cover body and a side surface of the bonnet as the air direction regulation means.

Air guide plate slanted upward or downward aslant is provided inside the cover body neat the exhaust port.

The outlet opening is provided at the upper end of the cover body when the air guide plate is slanted upward and is provided at the lower end of the cover body when the air guide plate is slanted downward.

Plural air guide plates are provided, the air guide plate upper than a vertical center of the cover body is slanted upward and the air guide plate lower than the vertical center is slanted downward, and the outlet opening is provided between upper and lower ends of the cover body and a side surface of the bonnet.

The cover body is formed integrally with the duct or is detachably attached to the duct.

With regard to the revolving working machine according to the present invention, as a fourth mode, a lid body covering an upper portion of the duct is provided detachably.

### EFFECT OF THE INVENTION

With regard to a revolving working machine according to the present invention, wherein a revolving body is provided on a traveling unit; the revolving body comprises a revolving frame, a counter weight is arranged at a rear portion of the revolving frame, an engine and a radiator are mounted on the revolving frame, and these members are covered by a bonnet; a cooling fan is arranged between the engine and the radiator; an exhaust port is provided in a side surface of the bonnet at a side of the radiator; an air exhaust duct is arranged between the exhaust port and the radiator; the cooling fan is rotatively driven by the engine so as to send cooling air to the radiator; and the cooling air passes through the radiator and is discharged out of the revolving body through the air exhaust duct and the exhaust port of the bonnet, a lower rear portion of the bonnet is notched along shape of a side surface of the counter weight and the exhaust port is shaped along the notch; and an air direction regulation means, regulating direction of exhaust from the exhaust port, is provided near the exhaust port.

Accordingly, the engine exhaust is not discharged along pertinent direction so that the engine exhaust does not blow against a tree close to a wall. Furthermore, the engine exhaust does not blow against a walker passing at the side of the vehicle.

With regard to the revolving working machine according to the present invention, as a first mode, a grille stairstep-like shaped in section is formed in the exhaust port, and in the grille, plural air guide plates are constructed by plate-like fins as the air direction regulation means so as to discharge exhaust upward or downward aslant.

Accordingly, the engine exhaust is discharged upward or downward so that the engine exhaust does not blow against a tree close to a wall. Furthermore, the engine exhaust does not blow against a walker passing at the side of the vehicle.

The air guide plate upper than a vertical center of the grille is slanted upward and the air guide plate lower than the vertical center is slanted downward.

Accordingly, the engine exhaust is not discharged horizontally so that the engine exhaust does not blow against a tree close to a wall. Furthermore, the engine exhaust does not blow against a walker passing at the side of the vehicle.

A stile is interposed between the plural air guide plates.

Accordingly, the distance between the adjacent air guide plates is not changed by air pressure of the engine exhaust and the air guide plates are reinforced.

The grille is detachably attached to the bonnet or the duct.

Accordingly, the maintainability is improved.

Otherwise, the grille is formed integrally with the duct of the bonnet, and a part of the plural air guide plates is detachable so that an opening, having enough area to insert a hand thereto, is provided by removing the part of the air guide plates.

Accordingly, the covered inside of the bonnet can be maintained easily. The maintainability is improved by simple structure. For example, the radiator arranged inside the grille can be maintained through the opening. Furthermore, in the case of exchanging cooling water in the radiator, a plug of a drain provided at the lower portion of the radiator can be detached only by detaching the lowest air guide plate without detaching the large bonnet.

With regard to the revolving working machine according to the present invention, as a second mode, air guide plates slanted upward or downward aslant is provided near the exhaust port in the duct as the air direction regulation means.

Accordingly, the engine exhaust is not discharged horizontally so that the engine exhaust does not blow against a tree close to a wall. Furthermore, the engine exhaust does not blow against a walker passing at the side of the vehicle.

The air guide plate upper than a vertical center of the duct is slanted upward and the air guide plate lower than the vertical center is slanted downward.

Accordingly, the engine exhaust is not discharged horizontally so that the engine exhaust does not blow against a tree close to a wall. Furthermore, the engine exhaust does not blow against a walker passing at the side of the vehicle.

With regard to the revolving working machine according to the present invention, as a third mode, a cover body is provided on the bonnet at an outside of the exhaust port, and an outlet opening is provided between an upper or lower end of the cover body and a side surface of the bonnet as the air direction regulation means.

Accordingly, the engine exhaust is discharged upward or downward so that the engine exhaust does not blow against a tree close to a wall. Furthermore, the engine exhaust does not blow against a walker passing at the side of the vehicle.

Air guide plate slanted upward or downward aslant is provided inside the cover body neat the exhaust port.

Accordingly, the engine exhaust is discharged upward or downward so that the engine exhaust does not blow against a tree close to a wall. Furthermore, the engine exhaust does not blow against a walker passing at the side of the vehicle.

The outlet opening is provided at the upper end of the cover body when the air guide plate is slanted upward and is provided at the lower end of the cover body when the air guide plate is slanted downward.

Accordingly, the engine exhaust is discharged upward or downward so that the engine exhaust does not blow against a tree close to a wall. Furthermore, the engine exhaust does not blow against a walker passing at the side of the vehicle.

Plural air guide plates are provided, the air guide plate upper than a vertical center of the cover body is slanted upward and the air guide plate lower than the vertical center is slanted downward, and the outlet opening is provided between upper and lower ends of the cover body and a side surface of the bonnet.

Accordingly, the engine exhaust is not discharged horizontally so that the engine exhaust does not blow against a tree close to a wall. Furthermore, the engine exhaust does not blow against a walker passing at the side of the vehicle.

The cover body is formed integrally with the duct or is detachably attached to the duct.

Accordingly, the engine exhaust is discharged upward or downward so that the engine exhaust does not blow against a tree close to a wall. Furthermore, the engine exhaust does not blow against a walker passing at the side of the vehicle.

With regard to the revolving working machine according to the present invention, as a fourth mode, a lid body covering an upper portion of the duct is provided detachably.

Accordingly, at the time of maintenance, by detaching the lid body, the cleaning, check and the like of the inside of the exhaust duct can be performed easily.

### BRIEF DESCRIPTION OF THE DRAWINGS/FIGURES

FIG. 1 is a side view of entire construction of a revolving working vehicle according to an embodiment of the present invention.

FIG. 2 is a side view of a revolving body.

FIG. 3 is a side view of a bonnet.

FIG. 4 is a plan view of schematic construction inside the revolving body.

FIG. 5 is a sectional front view of a grille.

FIG. 6 is a sectional front view of a grille of the second embodiment.

FIG. 7 is a sectional front view of a grille of the third embodiment.

FIG. 8 is a sectional front view of air guide plates.

FIG. 9 is a sectional front view of air guide plates of another embodiment.

FIG. 10 is a sectional front view of a cover body.

FIG. 11 is a sectional front view of a cover body of the second embodiment.

FIG. 12 is a sectional front view of a cover body of the third embodiment.

FIG. 13 is a perspective rear view of an air exhaust grille formed integrally with the bonnet.

FIG. 14 is a perspective view of detachable air guide plates.

FIG. 15 is a perspective rear view of an air exhaust duct arranged inside the bonnet.

### DESCRIPTION OF NODULES

1 a crawler traveling unit

8 a revolving body

15 a bonnet

15a an air exhaust duct

16 a grille

16a air guide plates

16b a stile

30 an engine

32 a revolving frame

34 a cooling fan

37 a radiator

### DETAILED DESCRIPTION OF THE INVENTION

The present invention is explained in detail below on the basis of attached drawings.

Firstly, explanation will be given on entire construction of a revolving working vehicle having exhaust structure of the present invention.

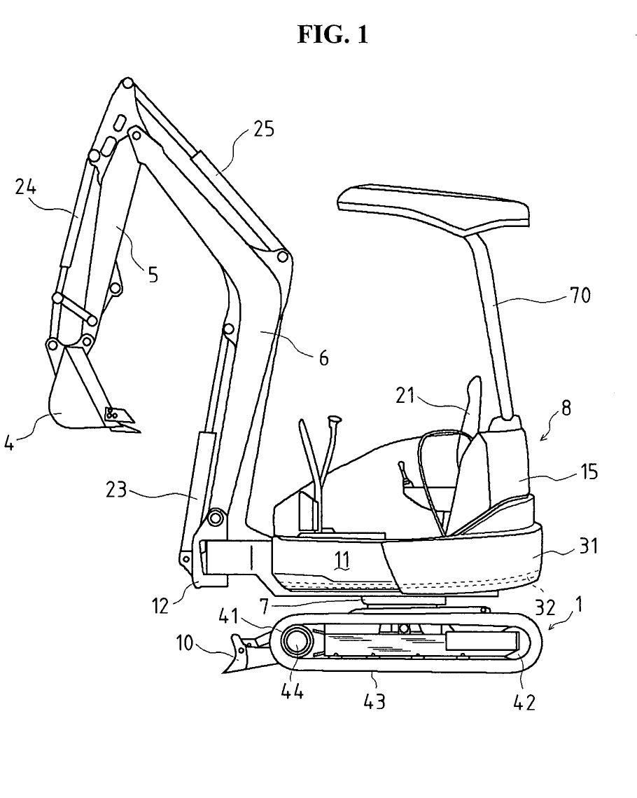

As shown in FIG. 1, with regard to the revolving working vehicle, a revolving base bearing 7 is arranged at a n upper center of a crawler traveling unit 1, and the revolving base bearing 7 pivotally supports a revolving body 8 so as to be revolvable laterally. A blade 10 is rotatably vertically disposed at one of front and rear ends of the crawler traveling unit 1.

A later-discussed engine 30 is mounted on the revolving body 8 and covered by an exterior cover (hereinafter, referred to as bonnet) 15. Furthermore, a seat 21 and operation equipments of the working machine are disposed on the revolving body 8. A boom bracket 12 is rotatably laterally attached to the front end of the revolving body 8, and a lower end of a boom 6 is pivotally supported rotatably longitudinally by the boom bracket 12. A basal part of an arm 5 is pivotally supported by the tip of the boom 6, and a bucket 4 or another attachment apparatus is attached to the tip of the arm 5. A canopy 70 is standingly provided on the rear portion of the revolving body 8.

A driving sprocket 41 is arranged at one of front and rear sides of the crawler traveling unit 1, and a driven sprocket 42 is arranged at the other side thereof. A crawler belt 43 is wound around the driving sprocket 41 and the driven sprocket 42. The driving sprocket 41 is driven by a hydraulic motor 44. A revolving motor is arranged between a revolving frame 32, arranged at the lower portion of the revolving body 8, and the revolving base bearing 7 so as to enable the revolving frame 32 to revolve.

The rearward projection length of the revolving body 8 from the revolution center is substantially the same as the distance from the revolution center to the side end of the crawler belt 43 so that the working vehicle is constructed as a so-called rearward small revolving type excavation machine which can revolve and work close to a wall.

Next, explanation will be given on the construction of the revolving body 8.

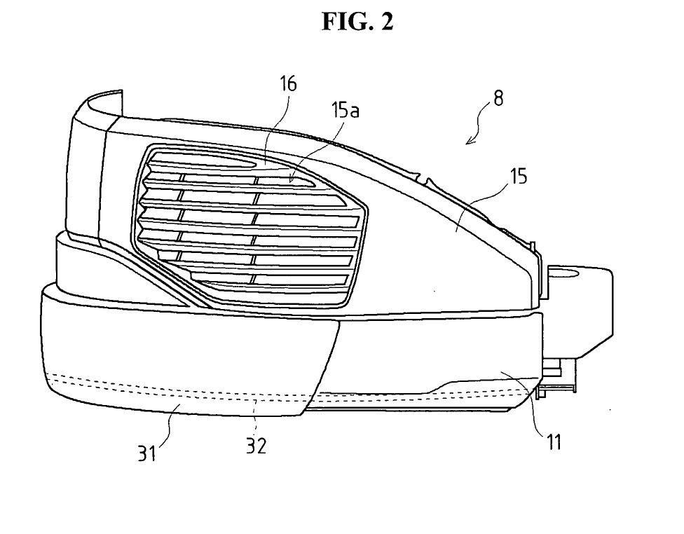

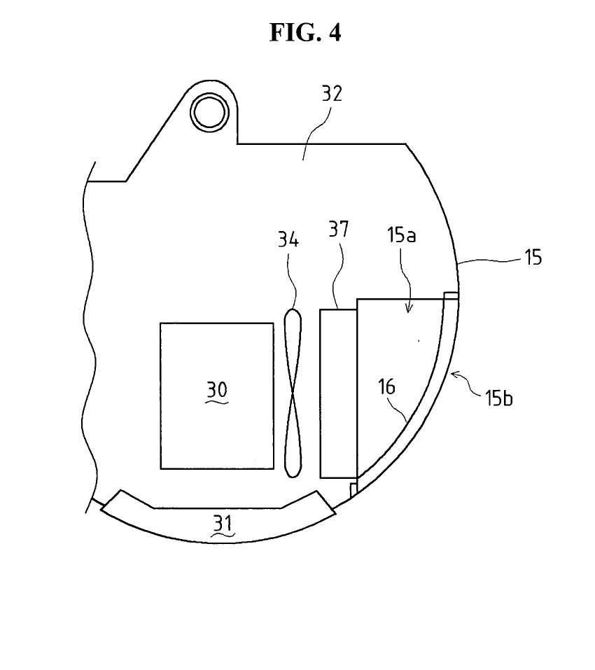

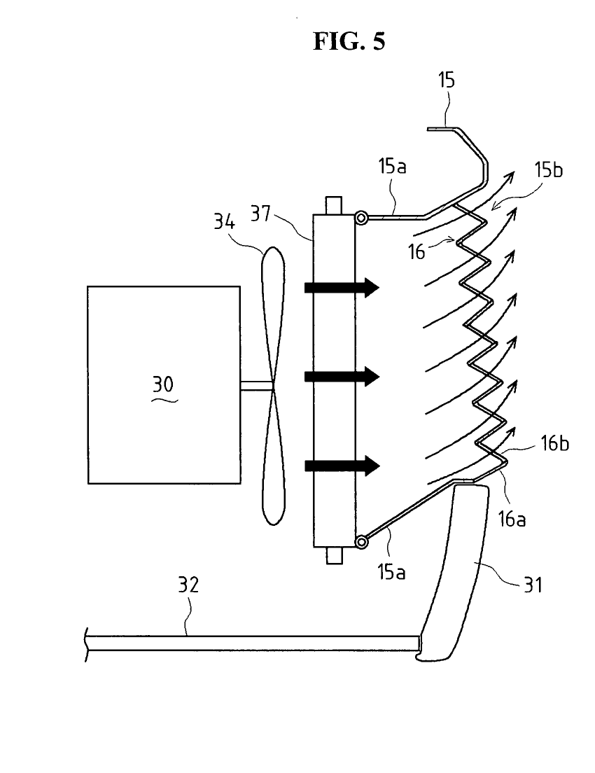

As shown in FIGS. 4 and 5, with regard to the revolving body 8, the engine 30, a radiator 37, a hydraulic pump, a pressure oil tank, a battery, a fuel tank and the like are mounted on the revolving frame 32, and these members are covered by the bonnet 15, side covers 11 (shown in FIG. 2) and the like. A cooling fan 34 is arranged between the engine 30 and the radiator 37. An exhaust port 15b is provided in the side surface of the bonnet 15 at the side of the radiator 37, and an air exhaust duct 15a is arranged between the exhaust port 15b and the radiator 37, whereby these members are arranged in series laterally. By driving the engine 30, the cooling fan 34 is rotatively driven so as to send cooling air to the radiator 37, and then exhaust passing through the radiator 37 and heated is discharged outward from the revolving body 8 through the air exhaust duct 15a and the exhaust port 15b provided in the bonnet 15.

A counter weight 31 is disposed in the rear portion of the revolving body 8, and the left and right sides of the revolving body 8 are covered by the side covers 11. The seat 21 is disposed at the substantial center of the revolving body 8.

In this embodiment, the exterior cover covering the engine, the radiator and the like comprises a left bonnet, a right bonnet, a rear bonnet and a front bonnet. However, two or more of them may be constructed integrally. The exhaust port is provided on the side surface of the exterior cover at the side of the radiator 37. In this embodiment, the exhaust port 15b is provided in the bonnet 15 of the right side.

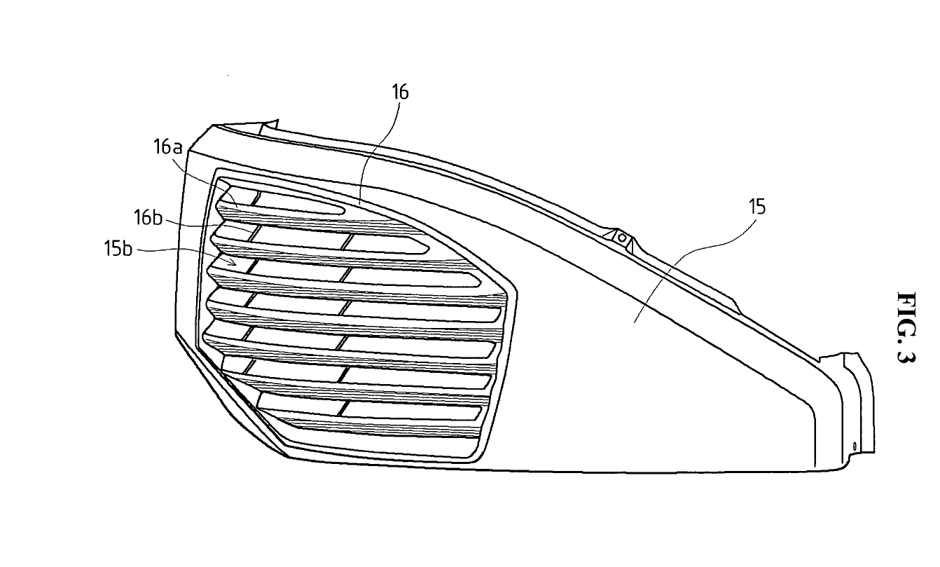

Explanation will be given on the construction of the bonnet 15 according to FIGS. 2 to 5.

As shown in FIG. 2, the bonnet 15 covers the upper side portion of the revolving body 8 and is formed along the shape of the side portion of the revolving body 8. The exhaust port 15b is provided in the side surface of the bonnet 15 at the side of the radiator 37 of the revolving body 8, and a grille 16, which has a stepped part (shown in FIG. 5) stairstep-shaped in section, is formed in the exhaust port 15b. In this embodiment, the grille 16 is arranged diagonally rearward. Means for changing the exhaust direction is provided in the grille 16. The grille 16 may be constructed integrally with the bonnet 15 or the outlet of the duct, or may alternatively be constructed by another member detachably. Air guide plates 16a are formed by plate fins in the grille 16 so as to change the exhaust direction of engine cooling air.

The rear portion of the bonnet 15 is formed along the shape of the counter weight 31 disposed in the rear portion of the revolving body 8, and the lower rear portion of the bonnet 15 is notched.

The grille 16 is lattice-like shaped and is stairstep-shaped in sectional front view. In the grille 16, the air guide plates 16a are longitudinally (or laterally) provided in parallel with each other in the vertical direction. Each of the air guide plates 16a is slanted upward outward so as to discharge exhaust from the engine 30 upward aslant. Stiles 16b are ladder-like suspended between the adjacent air guide plates 16a at suitable intervals so as to prevent the distance between each adjacent air guide plates 16a from being changed by the pressure of engine exhaust and to reinforce the air guide plates 16a.

The grille 16 constructed as mentioned above is attached to the exhaust port 15b provided in the bonnet 15 so as to change the engine exhaust direction. In addition, the stiles 16b are positioned to face the stiles and the side plates of the radiator from the outer side so as to prevent the increase of resistance of the exhaust as much as possible.

Accordingly, the grille changing the exhaust direction is provided in the bonnet 15 of the revolving body 8, whereby engine exhaust is directed upward so as not to blow against a tree or a walker close to a wall. The engine is discharge cooling type, whereby an operator room is not heated so as to keep the comfortability of the operator room.

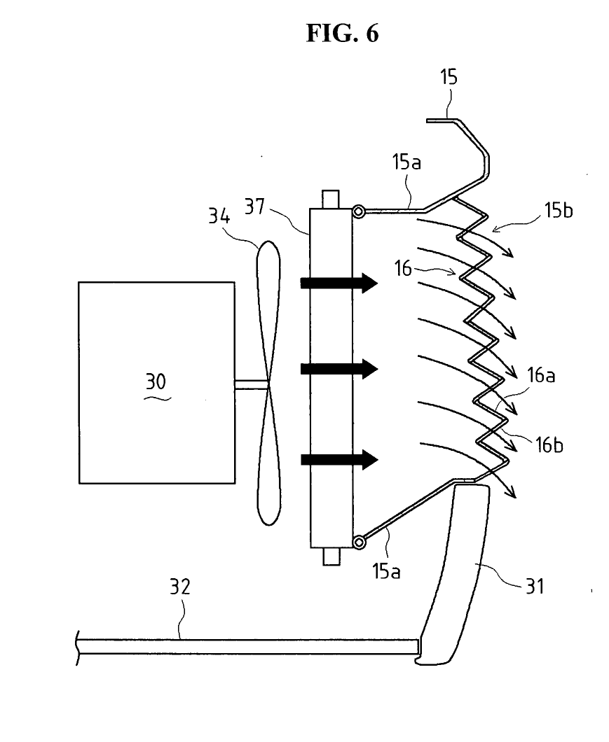

In addition, as shown in FIG. 6, the lateral air guide plates 16a formed in the grille 16 may alternatively be slanted downward.

By this construction, engine exhaust is discharged downward, whereby engine exhaust is directed upward so as not to blow against a tree or a walker close to a wall at the time of the work close to the wall.

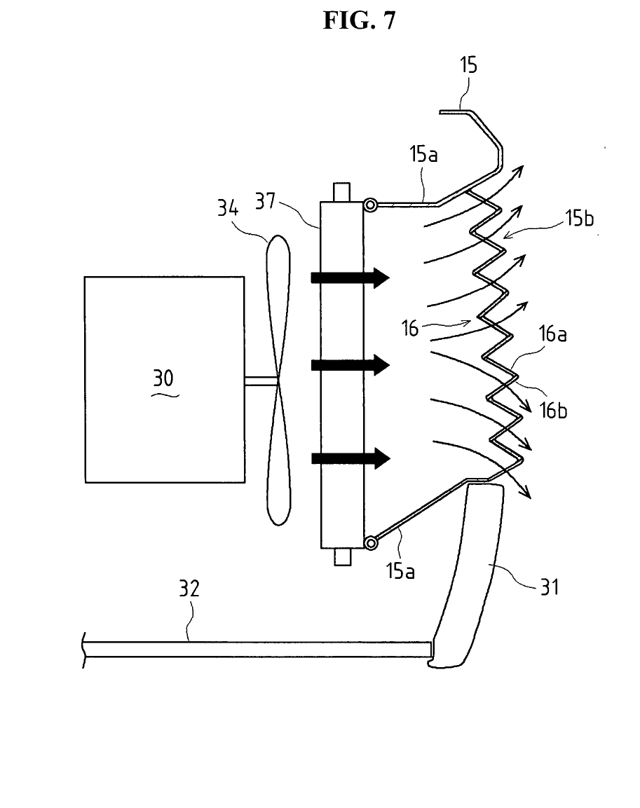

As shown in FIG. 7, it may alternatively be constructed so that the part of the lateral air guide plates 16a upper than the vertical center of the grille 16 is slanted upward and the part thereof lower than the vertical center of the grille 16 is slanted downward.

By this construction, engine exhaust is discharged upward and downward and is not discharged horizontally, whereby the engine exhaust does not blow against a tree or a walker close to a wall.

Accordingly, the exhaust direction changing means is provided in the air exhaust duct 15a provided in the bonnet 15 so as to direct engine exhaust upward, downward, or upward and downward, whereby the engine exhaust is not discharged horizontally. Therefore, the engine exhaust does not blow against a walker passing at the side of the vehicle. Furthermore, the engine exhaust does not blow against a tree close to a wall at the time of the work close to the wall so as not to blight the tree.

Next, explanation will be given on the second embodiment of the exhaust direction changing means.

In the above-mentioned first embodiment, the bonnet and the duct and the air guide plates, or the bonnet and the air guide plates, or the duct and the air guide plates are constructed integrally. However, in the second embodiment, the air guide plates are separated from the bonnet and the duct.

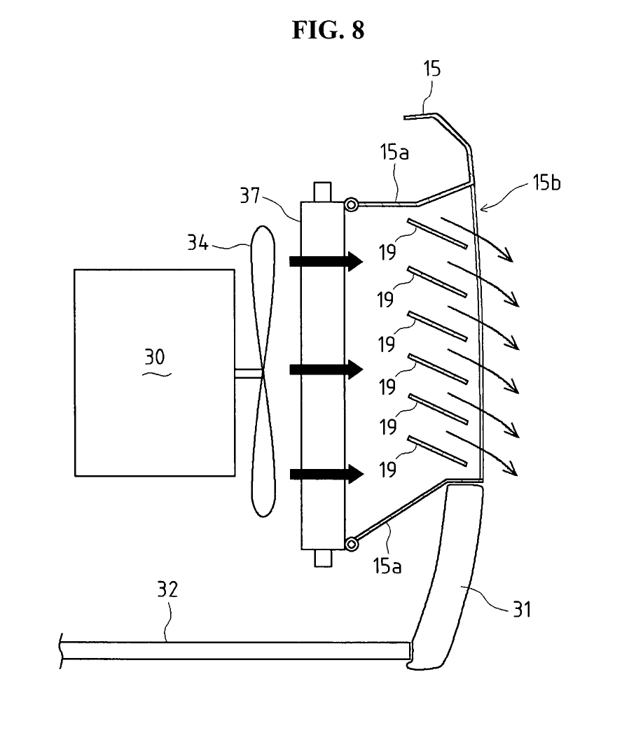

Namely, as shown in FIG. 8, plural air guide plates 19 are arrayed vertically so as to be in parallel to each other in the exhaust duct 15a or in the exhaust port 15b provided in the bonnet 15, whereby engine exhaust is discharged downward.

Each of the air guide plates 19 are spanned in the exhaust duct 15a arranged in the exhaust port 15b provided in the bonnet 15, and both ends thereof are fixed to the inner side surface of the exhaust duct 15a. The air guide plates 19 are arrayed vertically and slanted downward outward. Alternatively, the air guide plates 19 may be slanted upward outward (not shown).

By such construction, the engine exhaust is guided downward (or upward), whereby the engine exhaust is directed upward so as not to blow against a tree or a walker close to a wall at the time of the work close to the wall.

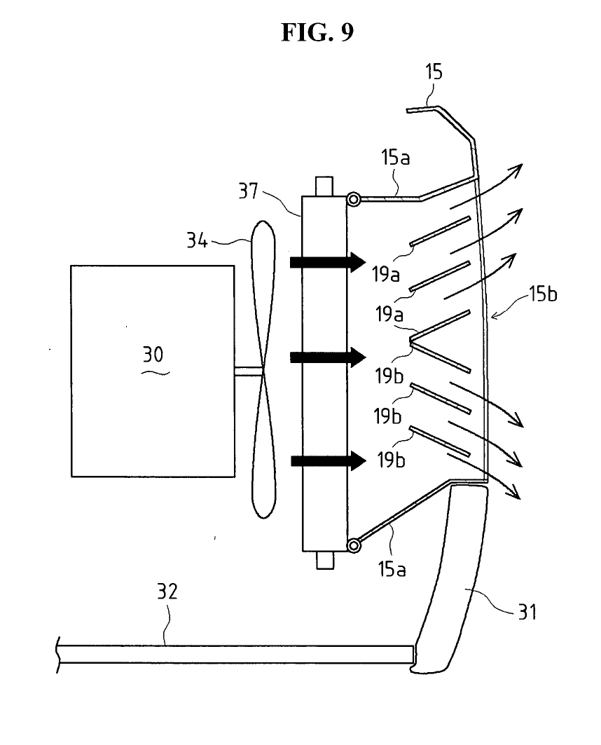

As shown in FIG. 9, it may alternatively be constructed so that the upper half of the air guide plates 19 are arrayed vertically is slanted upward and the lower half thereof is slanted downward, thereby directing engine exhaust upward and downward.

Namely, on the basis of the vertical center of the exhaust port 15b provided in the bonnet, air guide plates 19a in the upper half part is slanted upward and air guide plates 19b in the lower half part is slanted downward.

By this construction, the engine exhaust passing through the radiator 37 and entering the exhaust duct 15a is not discharged horizontally, whereby the engine exhaust does not blow against a tree or a walker close to a wall.

Alternatively, it may be constructed so that the grille is separated from the bonnet and the duct and the air guide plates are slanted upward, or slanted downward, or the upper half thereof is slanted upward and the lower half thereof is slanted downward (not shown). In this case, the grill is detachably fixed to the bonnet or the duct by bolts or the like.

Next, explanation will be given on the third embodiment of the exhaust direction changing means.

In the first or second embodiment, the direction of air is changed by the air guide plates. However, in the third embodiment, a cover body is provided outside the exhaust opening of the bonnet or the duct at a prescribed distance and an outlet opening is provided in the upper, lower or side portion of the part between the cover body and the opening end of the bonnet or the duct, whereby exhaust is guided upward or downward through the outlet opening. In addition, air guide plates may be provided in the opening or may not provided.

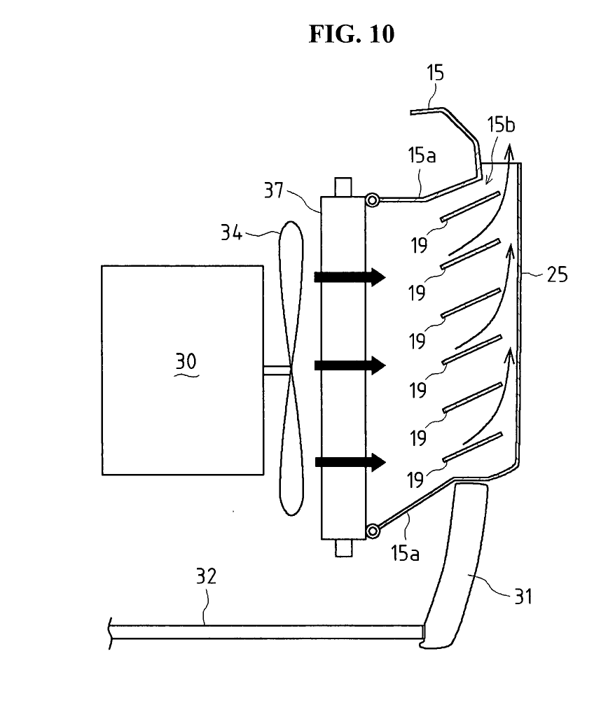

Namely, with regard to the construction that a cover body 25 is attached to the bonnet 15 as shown in FIG. 10, the cover body 25 is arranged outside the exhaust port 15b, provided in the bonnet 15 for discharging cooling air, with the position and size of the exhaust port 15b so as to discharge engine exhaust upward through a gap between the upper portion of the cover body 25 and the bonnet 15.

The cover body 25 is arranged outward from the bonnet 15 at a prescribed distance and is fixed so as to cover tightly the lower, left and right sides of the exhaust port 15b provided in the bonnet 15, whereby an opening is provided between the outer surface of the bonnet 15 and the upper portion of the cover body 25. Then, the engine exhaust is discharged only through the upper outlet opening. The air guide plates 19 are arranged in the exhaust port 15b provided in the bonnet 15 so as to guide the engine exhaust to the opening in the upper portion of the cover body 25.

By this construction, the engine exhaust is guided upward, whereby the engine exhaust is directed upward so as not to blow against a tree or a walker close to a wall at the time of the work close to the wall.

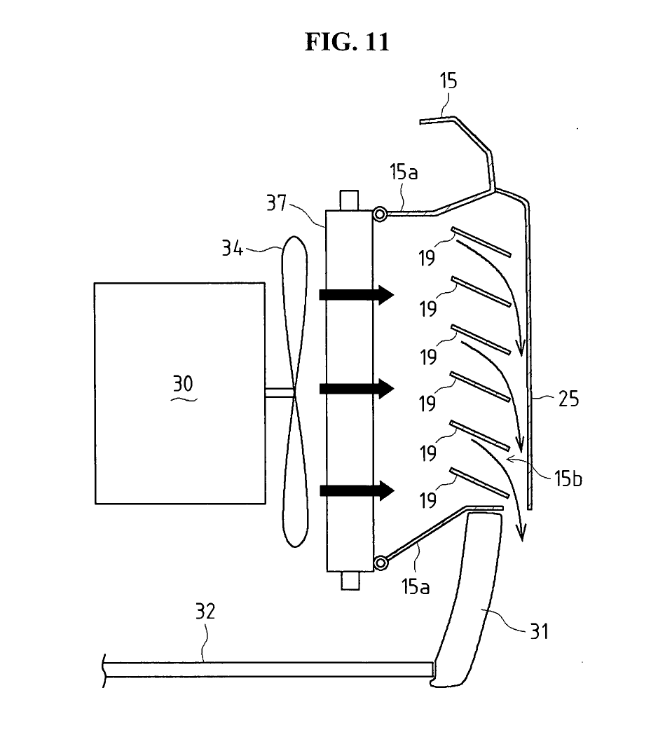

As shown in FIG. 11, in contrast with the above-mentioned mode, it may alternatively be constructed so that the cover body 25 is fixed to the outer surface of the bonnet 15 so as to cover tightly the upper, left and right sides of the exhaust port 15b provided in the bonnet 15, whereby an exhaust opening is provided downward. The air guide plates 19 are slanted downward.

By this construction, the engine exhaust is discharged only through the lower opening so that the engine exhaust is directed downward, whereby the same effect as mentioned above is obtained.

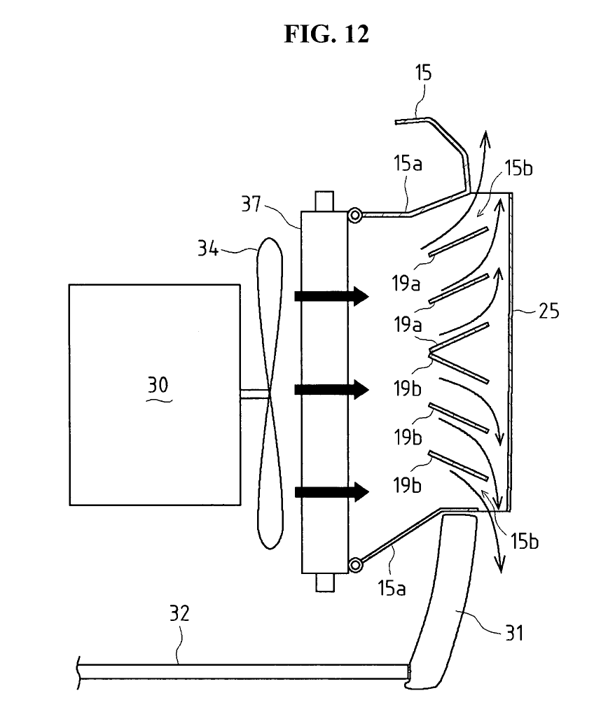

As shown in FIG. 12, it may alternatively be constructed so that the cover body 25 is fixed to the outer surface of the bonnet 15 so as to cover tightly the left and right sides of the exhaust port 15b provided in the bonnet 15, whereby exhaust openings are provided upward and downward.

In this case, the air guide plates 19a upper than the vertical center of the exhaust port 15b is slanted upward and the air guide plates 19b lower than the vertical center is slanted downward.

Accordingly, the air guide plates 19 are separately provided in the exhaust port 15b, the cover body 25 is separately provided on the exterior of the bonnet 15, and the upper and lower portions of the cover body 25 are opened, whereby engine exhaust is discharged only through the upper and lower outlet openings so that the engine exhaust is directed upward and downward. Therefore, the engine exhaust is not discharged horizontally, whereby the engine exhaust does not blow against a tree or a walker close to a wall.

In addition, the cover body 25 is larger than the exhaust port 15b so that exhaust is not discharged directly sideward. The cover body 25 may be detachable from the bonnet or the duct, or may alternatively be constructed integrally with the bonnet or the duct. For enlarging the opening area, the four corners of the cover body 25 are fixed to the bonnet so that four openings are provided upward, downward, leftward and rightward between the cover body 25 and the bonnet.

Next, explanation will be given on the embodiment that a part of the air guide plates, that is, one or more air guide plates are detachable from the grille in the first or second embodiment.

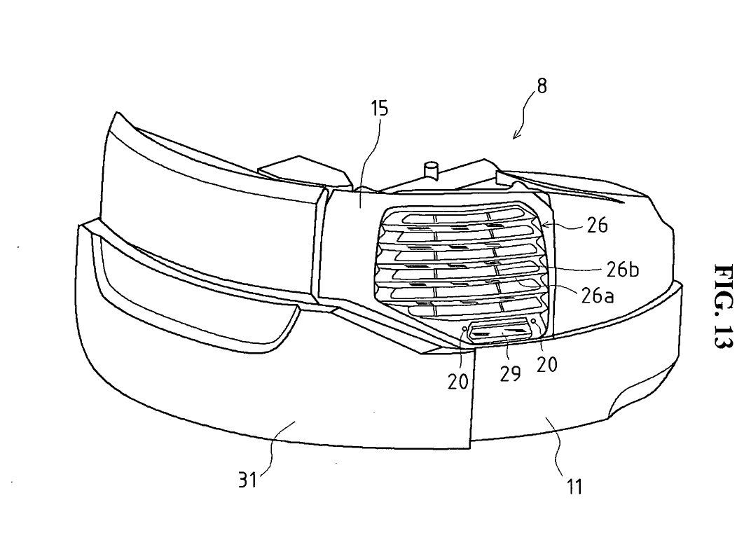

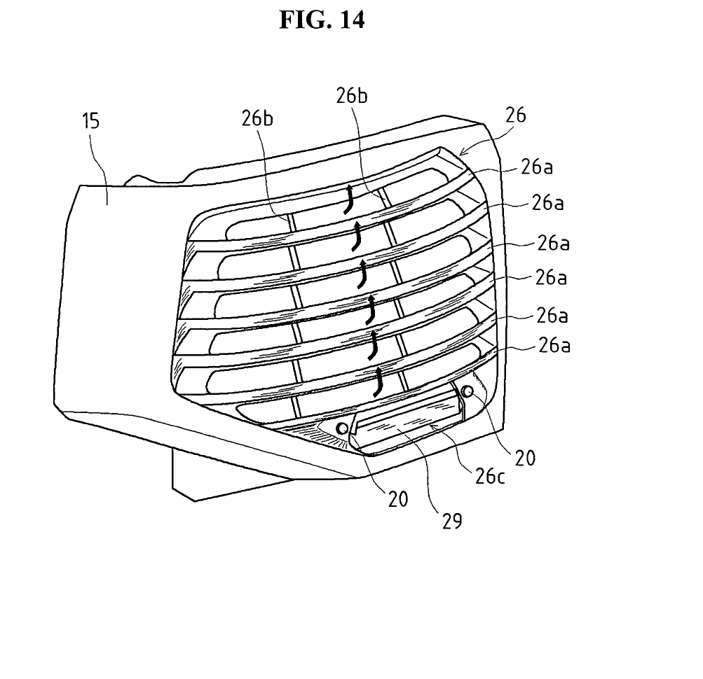

Namely, explanation will be given on the embodiment that the lowest air guide plate is detachable. As shown in FIGS. 13 and 14, an air exhaust grille 26 is provided integrally with the exterior of the bonnet 15 forming the revolving body 8 and is lattice-like shaped. Plural air guide plates 26a constituting the air exhaust grille 26 are slanted upward, and stiles 26b are ladder-like suspended between the adjacent air guide plates 26a.

An air guide plate 29 is detachably fixed to the lower portion of the air exhaust grille 26 by bolts 20 or the like and is slanted upward similarly to the air guide plates 26a. The bolts 20 are inserted into holes bored in the lower portion of the air exhaust grille 26 and screwed into the left and right ends of the air guide plate 29. Then, the air guide plate 29 can be detached by detaching the bolts 20.

By this construction, by detaching the bolts 20 of both sides, the air guide plate 29 is detached so that an opening, having enough area to insert a hand thereto, is provided in a lower portion of an opening 26c, whereby the maintenance work of the radiator and the like arranged inside the air exhaust grille 26 can be performed through the opening 26c. For example, in the case of exchanging cooling water in the radiator, a plug of a drain provided at the lower portion of the radiator can be detached only by detaching the lowest air guide plate 29 without detaching the large bonnet. In this case, by slanting the air guide plates 26a upward, a hand can be inserted downward easily, whereby the number of the air guide plates to be detached is reduced. In the case that a temperature sensor is arranged at the vertical center of the radiator, the temperature sensor can be judged its failure and exchanged easily by making the air guide plate, positioned the same height as the temperature sensor, detachable. Also, in the case that an apparatus to be cooled, such as an oil cooler or a condenser, is arranged between the opening and the air guide plates, by making the air guide plate, positioned the same height as the apparatus, detachable, the apparatus can be maintained easily by removing said air guide plate.

Accordingly, a part of the air guide plates of the air exhaust grille 26 provided integrally with the exterior of the revolving body 8 is detachable, whereby the maintainability is improved by simple structure.

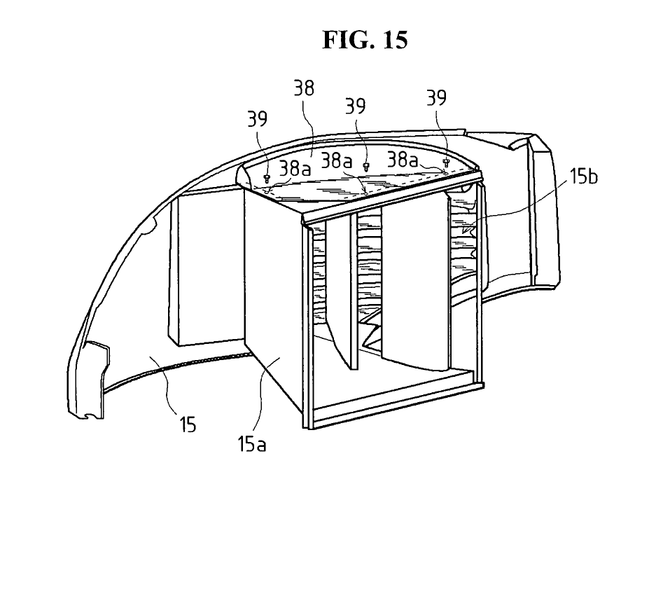

Next, explanation will be given on the structure of the exhaust duct 15a according to FIGS. 4 and 15.

As was previously mentioned, the exhaust duct 15a is arranged between the exhaust port 15b provided in the side surface of the bonnet 15 and the radiator 37.

As shown in FIG. 15, the exhaust duct 15a is arranged inside the bonnet 15 and is shaped like a box penetrated horizontally and covering the exhaust port 15b. The perimeter of the exhaust duct 15a is shaped triangular substantially when viewed in plan so as to cover the exhaust port 15b provided in the side surface of the bonnet 15 (see FIG. 4).

The outer perimeter of the top plate of the exhaust duct 15a is substantially fan-like shaped along the shape of the bonnet 15. The other part of the top plate is a lid body 38 along the shape of the upper portion of the exhaust duct 15a so that engine exhaust does not leak out from the upper portion of the exhaust duct 15a. Plural insertion holes 38a into which bolts or another fastening members are inserted are provided at the outer perimeter of the lid body 38 so as to fix the lid body 38 to the upper portion of the exhaust duct 15a by bolts 39.

The lid body 38 can be detached from the upper portion of the exhaust duct 15a easily by detaching the bolts 39. In addition, instead of the fixation by the bolts, a fingertip fastening member or inlay structure may alternatively be adopted, and the structure for fixation is not limited.

Accordingly, since the lid body 38 is detachably provided in the upper portion of the exhaust duct 15a, the upper portion of the exhaust duct 15a is closed at the time of working, and the upper bonnet is opened and the lid body 38 is detached so as to perform the cleaning, check and the like of the inside of the exhaust duct 15a easily at the time of maintenance.

### INDUSTRIAL APPLICABILITY

The present invention can be adopted to all use which is necessary to prevent the horizontal discharge of exhaust including heat or dust from the viewpoint of the environment.

What is claimed is:

1. A revolving working machine wherein:
(a) a revolving body is provided on a traveling unit;
(b) the revolving body comprises a revolving frame, a counter weight is arranged at a rear portion of the revolving frame, an engine and a radiator are mounted on the revolving frame, and these members are covered by a bonnet;
(c) a cooling fan is arranged between the engine and the radiator;
(d) an exhaust port is provided in a side surface of the bonnet at a side of the radiator;
(e) an air exhaust duct is arranged between the exhaust port and the radiator;
(f) the cooling fan is rotatively driven by the engine so as to send cooling air to the radiator; and
(g) the cooling air passes through the radiator and is discharged out of the revolving body through the air exhaust duct and the exhaust port of the bonnet, characterized in that:
(h) a lower rear portion of the bonnet is notched along shape of a side surface of the counter weight and the exhaust port is shaped along the notch; and
(i) an air direction regulation means, regulating direction of exhaust from the exhaust port, is provided near the exhaust port.

2. The revolving working machine as set forth in claim 1, wherein a grille stairstep-like shaped in section is formed in the exhaust port, and in the grille, plural air guide plates are constructed by plate-like fins as the air direction regulation means so as to discharge exhaust upward or downward aslant.

3. The revolving working machine as set forth in claim 2, wherein the air guide plate upper than a vertical center of the grille is slanted upward and the air guide plate lower than the vertical center is slanted downward.

4. The revolving working machine as set forth in claim 3, wherein a stile is interposed between the plural air guide plates.

5. The revolving working machine as set forth in claim 2, wherein the grille is detachably attached to the bonnet or the duct.

6. The revolving working machine as set forth in claim 2, wherein the grille is formed integrally with the duct of the bonnet, and a part of the plural air guide plates is detachable so that an opening, having enough area to insert a hand thereto, is provided by removing the part of the air guide plates.

7. The revolving working machine as set forth in claim 1, wherein air guide plates slanted upward or downward aslant is provided near the exhaust port in the duct as the air direction regulation means.

8. The revolving working machine as set forth in claim 7, wherein the air guide plate upper than a vertical center of the duct is slanted upward and the air guide plate lower than the vertical center is slanted downward.

9. The revolving working machine as set forth in claim 1, wherein a cover body is provided on the bonnet at an outside of the exhaust port, and an outlet opening is provided between an upper or lower end of the cover body and a side surface of the bonnet as the air direction regulation means.

10. The revolving working machine as set forth in claim 9, wherein air guide plate slanted upward or downward aslant is provided inside the cover body near the exhaust port.

11. The revolving working machine as set forth in claim 10, wherein the outlet opening is provided at the upper end of the cover body when the air guide plate is slanted upward and is provided at the lower end of the cover body when the air guide plate is slanted downward.

12. The revolving working machine as set forth in claim 10, wherein plural air guide plates are provided, the air guide plate upper than a vertical center of the cover body is slanted upward and the air guide plate lower than the vertical center is slanted downward, and the outlet opening is provided between upper and lower ends of the cover body and a side surface of the bonnet.

13. The revolving working machine as set forth in claim 9, wherein the cover body is formed integrally with the duct or is detachably attached to the duct.

14. The revolving working machine as set forth in claim 1, wherein a lid body covering an upper portion of the duct is provided detachably.
